(19) United States
(12) Patent Application Publication
(10) Pub. No.: US 2009/0328088 A1
(43) Pub. Date: Dec. 31, 2009

(54) Iterative Media Playing by increment and decrement of an Ad-to-Program Variable

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 12/164,038

(22) Filed: Jun. 28, 2008

(51) Int. Cl. H04N 7/16; H04N 7/025

(52) U.S. Cl. 725/10; 725/34

(57) ABSTRACT

A new paradigm of watching television allows watching programs and watching ads and maintaining a score that is based on the times of watching the programs and the ads. The paradigm can be carried out by increasing the value of a variable when programs are watched and decreasing the value of the variable when ads are watched. The user can also buy ad credits, or can receive them as an incentive to buy a product.

### BACKGROUND

The original versions of over-the-air media transmissions, such as television and radio, used for real-time paradigm. The program is transmitted over a common medium, the airwaves, and received by everyone within range. More advanced paradigms made available the ability to deliver new forms of media to consumers. Cable and satellite allow providing real-time programming, and programming on-demand. Digital video recorders allow recording the programming that was otherwise real time received over the channel, and playing it back later, e.g. at a time subsequent to its receipt. Similar technologies for listening to music have evolved, including MP3 players and other similar technology.

Initial versions of these systems were commercial supported. Advertisers would pay a certain amount to advertise—on the presumption that users would view these advertisements. Later systems obtained subscriptions from users and required the users to pay for those subscriptions. Subscription tv avoids the need to satisfy advertisers. Hence, many video on demand systems and video downloading systems require subscriptions to the service, in lieu of advertisements.

Digital video recorders, however, are a self-help form of video on demand. The digital video recorder typically records the show off of the real time media such as cable, satellite or broadcast. The user stores information indicative of the program on a hard drive. The information is later played back. Many advertisers resist the digital video recorder since it provides the ability to circumvent the commercials. In essence, the advertisers know that only a certain percentage of people will not watch their commercials, and this hence reduces the number of people who see the commercials, and hence reduces the value of the advertising.

Technology has advanced in other ways. Mass storage has become smaller and cheaper. For example, 60 GB or even larger nonvolatile solid-state memories are available. Moreover, users often used their personal devices, such as PDAs and the like, as media players both for music and for videos.

### SUMMARY

The present application describes a new way of viewing and distributing media. Embodiments describe operating using video and television. However, it should be understood that these same techniques can be used for delivering any kind of media including still pictures and sound.

### BRIEF DESCRIPTION OF THE DRAWINGS

In the drawings:

FIG. 1 shows a block diagram of a system using cellular phones which receive information wirelessly;

FIG. 2 illustrates an interactive advertisement determination part;

FIG. 3 shows a flowchart of operation; and

FIG. 4 illustrates channel number selection on an internet-connected device.

### DETAILED DESCRIPTION

An embodiment describes media information, and more specifically, video programming and commercials, being sent asynchronously and stored for later playback. The playback operation uses an advertising paradigm for asynchronous playback. In an embodiment, a variable is used to store values which indicate when to play content, and when to play advertisements. A scoring system is used which determines credits towards advertising, both from watching ads, and from other operations other than watching ads.

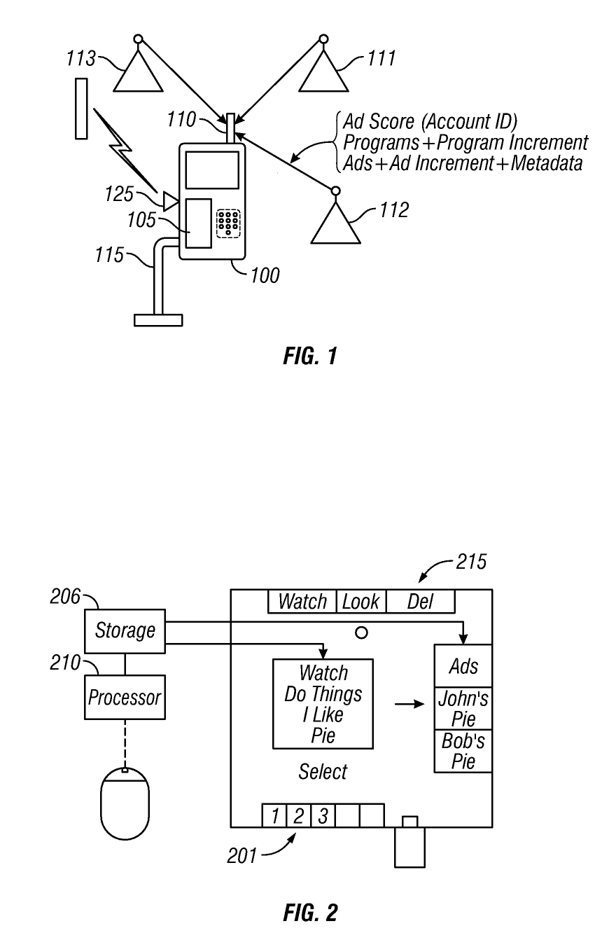

The embodiment of FIG. 1 shows a portable media playing device 100, which can be an MP3 player or a video player, for example. In one embodiment, the media player device may include a solid state memory 105 with a high capacity hard drive; such as 60 GB to 100 GB or more. The device also includes the ability to reproduce media from the hard drive, e.g., to play sound and/or video. The device may be a cellular telephone which has a wireless capability 110, or may alternatively or in addition include wired capability 115. In an embodiment, the device 100 includes cellular phone electronics, and the wireless capability 110 is shown communicating with wireless towers 111, 112 and 113 for example.

Wireless telephones conventionally communicate with the base stations in order to keep the communication intact. For example, wireless phones typically communicate various kinds of information as part of a periodic communication with the base station, e.g., a pilot signal. The base station therefore knows that the telephone is in a specific location, that the telephone is on, and various other information about the telephone.

According to one embodiment, as part of this communication, there may be additional overhead bits sent to the telephone and stored therein. These bits may be sent as part of the pilot signals, or alternatively as other communications. For example, the system may send this video information to all phones, or to groups of phones. Chunks of information can be sent at different times; e.g., 20 Kbytes of information can be sent at each of a number of different times. Associated information can be associated with the program information, e.g., metadata. The metadata can represent information about the content of the program, and can also represent a credit value of the program, used as described herein.

As part of this additional information, the system may send video, commercials, and other information that is separately stored in the nonvolatile memory 105.

The information in nonvolatile memory 105 can be retrieved and played by a user.

According to an embodiment, advertising material, e.g., commercials are also sent to the phone, and stored therein. Advertising metadata may also be stored, including advertising score metadata.

Commercials are played based on an ad score that may be individually set in the phone, and/or may be sent as part of the communication so that the ad score can be “shared” among multiple devices. Each program that is watchable is associated with a program increment that indicates how much a score is reduced when a unit part of that program is watched. For example, the ad score may go down by 1 point for each 2 minutes of a program that is watched. More popular programs may reduce the ad score by 1.25 points for each 2 minutes of program watching.

Each ad is also associated with an ad increment that sets the amount of increase to the ad score when that ad is watched. For instance, the score may increase by 1 for each 15 seconds of advertisement that is watched.

The score thus increases per unit time when the ads are watched; decrease per unit time when the program is watched. The metadata may indicate information about the advertisement that indicates which ad to play to fit to demographics of the user who is watching. In one embodiment, the user may also enter or otherwise store personal information on their communicating device 100. According to another embodiment, a system may deduce personal information based on what the user does and the user's habits.

Programs can be watched on the embedded display screen 120. The programs can also be watched on external displays. The portable device may include a projector part 125 that allows projecting onto a screen. It may also use some wireless communication format, such as wireless ethernet to display on an external television. A wired connection such as 115 may also be used to connect to an external screen.

However displayed, the display may take the form shown in FIG. 2. This system stores various program information which can be selected as 201. Programs may be stored automatically, or the user can select which programs to store. The user can play a program by actuating displayed information associated with that program.

For example, when the user selects one of the programs by number shown as 201 in FIG. 2, information about the program is displayed on the screen. The user can choose to watch that program, to bookmark it, delete it, or aany other action.

The programs that are watched and the amount of time that they are watched is monitored. This information, for example, may be stored in the storage unit 206, as metadata associated with the user's watching characteristics.

When it comes time to play commercials, as described herein, those commercials are selected for playing based on one or more of the time of day, user's watching habits, the criteria paid for by the advertiser, and/or others. Different ways of booking commercials may be done according to the present system. One aspect may be that the commercial is always played at a certain time in a specified show, rather than at a certain time. This may be demographically appropriate for users who are watching that show. For example, an advertiser can book their commercial to be played during SpongeBob cartoons. Another aspect may allow commercials to always be played at a certain time of day no matter what kind of show is being watched. Yet another aspect may be complete commercial metadata, where the commercial is played to specified people who watch certain kinds of programs based on metadata in those programs. For example, the metadata may be related to what kinds of shows are played what kinds of times of day; e.g., between 10 and 2 p.m. of the time on TV, and/or variety daytime shows. For example, each show may have a certain rating or set of ratings. Each episode may also have ratings or sets of ratings. For example if a user is watching Oprah, this may have a first set of ratings as women's show variety. However there may be second set of ratings. When the diet doctor is on, the show may be rated as women show variety: diet doctor. Other ratings may also be analogously used.

The user accumulates metadata score based on the shows they watch. Different users may watch the television at different times of day, however. A housewife may stay home and watch the television during the day, and a first set of metadata may be specific to the time of day while kids are in school say between 9:30 p.m and 3 pm. When the husband comes home and until the kids go to sleep, family shows maybe watched, so family hour may be defined between six and 9 p.m. After 9 p.m., the husband and wife may be assumed to watch. The metadata may be specific to hours, times of day, or any other aspect.

Based on the information about the ads which is also put in metadata, a specific ad is selected from among the stored ads and played.

In operation, the system uses a processor such as 210 to execute a stored routine that plays back the information. The processor may adaptively make determinations of what ads should be played.

According to an embodiment, the user to float their cursor over various ads, and indicate some information about the ads. The kind of information they can be presented, however, may be limited. For example according to one embodiment, the system may allow the users to customize their advertisements in return for a little information about the user. For example, the user may float their cursor over a beer ad, and say I'm a Mormon, this ad is useless for me. This can be added to the metadata.

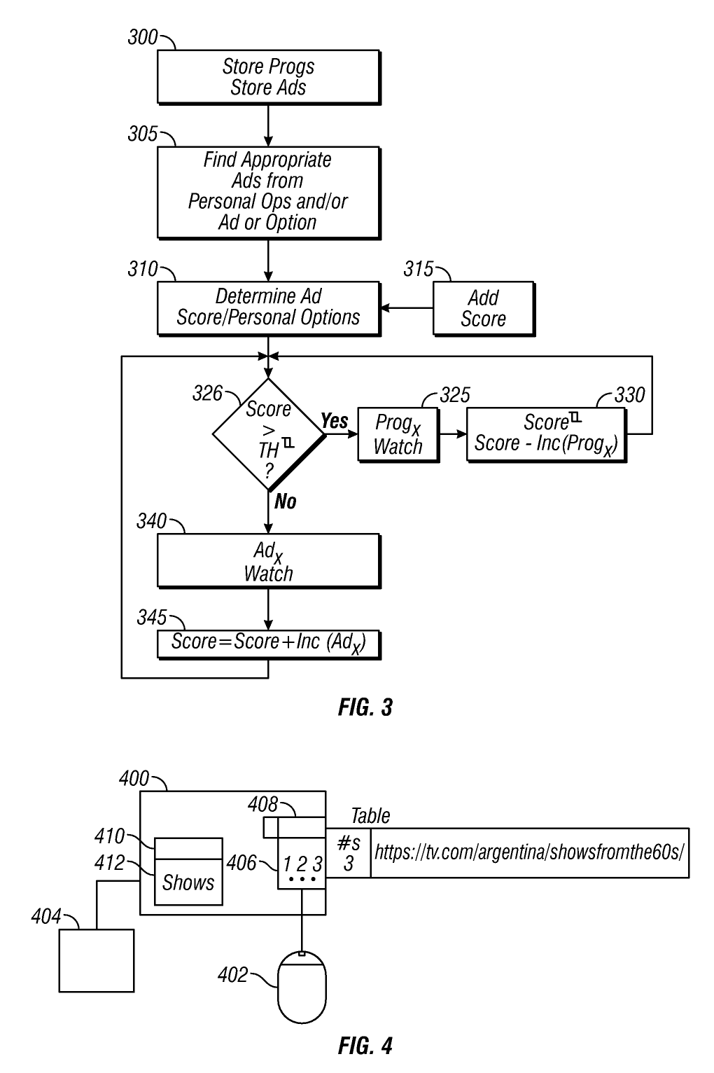

The processor may execute the routine shown in FIG. 3 to carry out an ad credit operation. According to one embodiment, an ad gets ad credit only when the television actually detects a person in its proximity, using the heat detector element shown as 215. According to another embodiment, the ads are played at a duty cycle at any time, and users can walk away during the ads. Still, however, this provides a higher likelihood that the user will go actually see the ads as compared with other systems in which the shows can be recorded using a digital video recorder.

When the user watches an ad, they get a ad credits for watching the ad. These ad credits may increment the value of a variable, for example, an ad score. When the user watches programs, they either get program credits, or according to another embodiment, the ad credits may be reduced. Both the programs and the ads may include individual values indicative of their weighting. For example, some ads may get more ad credits than others when watched. Based on the amount of ad credits, some shows may require advertisements more frequently than others, or require that ads be watched for longer amounts of time. First run shows, for example, may require more ads than reruns.

This system can also be used in a real-time paradigm, in which the show is received in real time, and the ads are stored in non real time and played during breaks in the show. For example, during a football game, the show may be received in real time over the channel, and displayed. The show can either be received as a broadcast, or vie a peer to peer communication. However, many of the commercials or advertising content may be received off-line, and previously stored.

The process may proceed according to the flowchart of FIG. 3. Programs and ads are stored at 300.

At 305, appropriate ads for playing during programs are found from one or more of personal options, previous viewing characteristics, ad data and/or other options.

310 represents determining the “ad score”. The ad score in the embodiment is a variable that indicates the total score accumulated from watching programs, ads and from externally obtained supplemental scoring parts. This variable may be incremented and decremented based on the watching.

During the normal watching of a television show, the value of the ad score variable goes up while commercials are being watched, and goes down while programs are being watched of course, this can be reversed in sense. The amount by which the value goes up when the ads are being watched is between 5 and 15 times that of the value of which the variable decreases while the program is being watched. The values may be different depending on the kind of show. For example, first-run shows may have higher reduction rates for the ad score than repeats and the like. This enables different channels or networks to compete by saying our reduction rate is higher than they are reduction rate for example.

The user can watch the programs in the normal way, where the score goes up when commercials are watched until the score reaches a certain level. Then the score goes down while the programs are watched until the score reaches a certain level. This normal watching intersperses commercials and programs according to a formula/duty cycle that is based on the reduction rate attributable to the program, and the increase rate attributable to the commercials. This lets you watch a few minutes of programs than a few minutes of commercials.

315, allows a score to be added to the user's overall ad score based on something that the user does outside of watching TV. The score can be added, for example, by the user purchasing either the credits directly or by purchasing some item that gives credits as a perk for the purchase. A user can in essence purchase a month of commercial free television. Their score is either frozen for a month, or increased by an amount equivalent to a month of programming. The purchase can use a secret code of the type used to add minutes to a prepaid cell phone or in calling cards, or a technique where ad score is directly added to a user's account. Another embodiment, however, allows the user to obtain score increases from a seller.

Say one of the big advertisers on channel x is General Motors. General Motors could advertise, for example, “watch no commercials for a year if you buy a GM car”. Since General Motors is an advertiser, they can work out a payment arrangement with one or all of the networks to allow providing these ad credits to a user. General Motors can then give the user some bulk number of points which is estimated to last a year. Or, alternatively, the system can add a special value which prevents the ad score from changing for a specified time; for example between a week and a year. During this time, the user gets to watch the programs without advertisements.

In another embodiment, buying a product provides a kind of ad credit that you cannot get by purchasing. For example, you may be able to purchase minutes of ad credits. However, buying a product may provide you with an unlimited bulk time of ad credits, e.g., a month of unlimited watching.

Certain shows, for example real-time shows, may be excluded from the ability to prevent commercials. Some shows may for example have other parts that can be played instead of the commercials, for example they may have additional content for commentary, extra scenes, or newsbreaks that can be played in place of the commercials when a user is watching a real time show. Various kinds of noncommercial content can be played to users who are watching live TV who have opted out of the commercials. This information may be downloaded along with the commercials and also played according to the metadata.

In this way, however, users can receive commercial credits for things they do. They can receive commercial credits as reward points for using certain kinds of grocery stores or other stores.

The ad score may determine whether ads are played based on the relationship between the ad score and a special threshold, e.g. the number zero.

At 320, so long is the user's current score is greater than the threshold, they are allowed to watch programs at 325. Program x has associated therewith an increment, that represents how much the score reduces over time when watching program x. At 330, the user's score goes down by that increment.

The score maybe reduced, for example, by the amount for each show chunk time. The chunk time may be 2 minutes for a show; 15 seconds for a commercial.

The loop continues until the score is less than the threshold. At 320, there may be some hysteresis in the system, so that the user automatically gets to watch for example 5-7 minutes worth of programs prior to watching the commercial. However, when the score is found to be lower than the threshold at 320, control passes to 340, requiring the user to watch an advertisement, here advertisement x. At the end of each segment of the advertising, here 345, the score is increased by an increment associated with the advertisement.

For example, the each increment of program watching maybe two minutes, and at the end of each program increment, the score is checked. After the user has watched enough programming to increase their score above the threshold by the amount indicated by the hysteresis, the result at 320 is changed, and the user is then allowed to watch programming again. Note that by setting the amounts of the increments for the ads in the program, this system essentially mathematically defines the amount of program that is watched followed by the amount of advertisement that is watched associated with that program. While the user watches normal TV, their score may reduce, and while they watch advertisements, their score may increase. This sets the duty cycle between watching TV and watching commercials.

User controls may also be possible. The user, for example, may choose to watch all of the commercials at once. This may be used, for example, in conjunction with the person detector, so that it can automatically detect when the user is present. This avoids the user simply selecting “watch” all the commercials and then walking away, then watching the programs commercial free.

Another embodiment is illustrated with reference to FIG. 4. In this embodiment, a television over Internet system may be carried out. This may use a system which alternately shows programs and commercials, or may use a system that shows programs side-by-side with commercials as in FIG. 2. In the FIG. 4 embodiment, the computer, shown as 400, stores a table that represents relationships between numbers which we will call channel numbers and specified website addresses. For example channel number 3 may represent http://www.TV.com/Argentina/shows_from_the_60s. The user may be allowed to define these numerical relationships on their computer or cell phone. The user can then select “watch computer channel 8” to bring up that website address. Some of these may alternatively be restored. The user can interact with the computer either using a remote control shown as 402, or using a keyboard and mouse shown as 404, or by selecting numbers on the screen. The user can select numbers from the box 406, or can type numbers into the box 408. When the user enters a number, the screen shows the website address 410 associated with that number, along with a brief description 412 of the programming that is carried on that website address. These website addresses may represent pay television, or may be free sites. The basic idea, however, is that like channel numbers on conventional TV, the user can enter a channel number and have that translated into website addresses.

According to another embodiment, this system may be used on alternative players. For example, in addition to watching this on a television (e.g., broadcast, cable or satellite), or over a cell phone link or over a PDA, or on a computer connected to the internet, this can be other kinds of media, such as a special purpose player over Wimax or others.

In addition, while the above describes the program being received asynchronously, for example on pilots of a cell phone, and alternative allows downloading programs. In an embodiment, this may include downloading over a cellular network, over the Internet, e.g., over peer-to-peer programming. Websites can also be used for the downloading of the programs.

Another embodiment may store copyright information in the metadata associated with the program, and part of that copyright information includes information about how much advertising needs to be played.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes certain kinds of operations over the internet, any other way of interacting via a shared network can be similarly controlled in this way. Other media can be recorded and played back in this way. The ad credits and scores can take different forms. These ad credits and scores can also be individualized for different media, e.g., for different networks, or channels or the like. The embodiment describes using a single variable, but multiple variables can be maintained, for example, a first variable for programs, and a second variable for ads. The ad score is described as being numerical, but more generally can be any criteria that represents an amount of watching of ads and programs.

Also, the inventor intends that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method comprising:
storing first data indicative of programming, and second data indicative of advertisements;
monitoring an amount of program watched and an amount of commercial that is watched;
using results from said monitoring to automatically determine when to display said first data indicative of programming and when to display said second data indicative of advertisements.

2. A method as in claim 1, wherein said using comprises first changing a variable information when said programming is watched and second changing variable information when said advertisements are watched.

3. A method as in claim 2, further comprising storing associated data along with said first and second data, said associated data indicating an amount by which said variable information is changed when at least one of said first and second data is watched.

4. A method as in claim 1, further comprising storing first associated data indicative of said advertisements, and using said associated information to select at least one of said advertisements for playing, based on said associated information.

5. A method as in claim 4, wherein said associated data represents contents of the advertisements, and further comprising second determining associated information indicative of which of said first data indicative of programming has been displayed, and using said associated information to select at least one of said advertisements for playing, based on said associated information.

6. A method as in claim 4, wherein said first associated data represents a time of day that the advertisement should be played, and using a current time of day to determine an advertisement to be played based on said associated information.

7. A method as in claim 2, further comprising storing programming increment data associated with each of a plurality of programs, said programming increment data indicative of an amount by which said variable information is changed when an associated program is watched, and said programming increment data for a first program being a different amount than a programming increment data for a second program.

8. A method as in claim 2, further comprising storing an advertising increment data indicative of an amount by which said variable is changed when said advertisements are watched, and wherein said advertising increment data for a first advertisement has a different value than an advertising increment data for a second advertisement.

9. A method comprising:
determining a ad score criteria which is based on both of a viewer watching advertisements and is also based on at least one other feature other than the viewer watching advertisements; and
using said ad score criteria to determine when the user is allowed to watch programs, and when the user needs to watch advertisements before the user can watch programs.

10. A method as in claim 9, further comprising storing at least multiple advertisements in a way that allows said advertisements to be played at some time after said storing, and selecting one of said multiple advertisements from the stored multiple advertisements, and playing back the selected advertisement based on said using.

11. A method as in claim 9, wherein both programs and advertisements are stored in a way that allows said programs and advertisements to be played back at some time after they are stored, and wherein a ratio between playing back of programs and playing back of advertisements depends on said ad score criteria.

12. A method as in claim 9, wherein said each of a plurality of stored programs includes an increment by which said said ad score criteria is changed when said program is watched.

13. A method as in claim 12, wherein said increment is different for a first of said programs than an increment for a second of said programs.

14. A method as in claim 13, wherein each of a plurality of stored advertisements also includes an increment by which the score is changed when said advertisement is watched.

15. A method as in claim 14, wherein said increment is different for a first said advertisements than it is for a second of said advertisements.

16. A method as in claim 9, wherein said operations other than watching ads comprise purchasing advertising credits which change said ad score criteria in a way that allows watching fewer advertisements.

17. A method, comprising:
storing program information in a memory;
storing metadata that indicates information about said program information in said memory, wherein said metadata includes information indicative of a ratio between an amount of programs that can be watched and an amount of advertisements that must be watched to see said program; and
playing back said program using both information and said metadata to determine when to play programs and advertisements to play.

18. A method as in claim 17, further comprising storing plural advertisements, and using said metadata to determine both which advertisement to play and when to play said advertisement.

19. A method as in claim 18, further comprising maintaining an ad score criteria that is changed in a first way when programs are watched, and changed in a second way that counteracts the change in the first way when advertisements are watched, and further comprising using said ad score criteria to determine when to allow programs to be watched and when to require advertisements to be watched.

20. A program playing device, comprising:
a memory, storing first data indicative of programming, and second data indicative of advertisements;
a player part, monitoring an amount of program watched and an amount of commercial that is watched and using results from said monitoring to automatically determine when to display said first data indicative of programming and when to display said second data indicative of advertisements.

21. A player as in claim 20, wherein said player part maintains at least one variable that changes in a first way when said programming is watched and changes in a second way that counteracts the change in the first way when said advertisements are watched.

22. A player as in claim 21, wherein said memory also stores increment data indicating an amount by which said variable information is changed when at least one of said first and second data is watched.

23. A player as in claim 22, wherein said memory stores increment data that includes program increment data associated with each of a plurality of programs, indicative of an amount by which said variable information is changed when an associated program is watched, and said program increment data for a first program being a different amount than a program increment data for a second program.

24. A method as in claim 23, wherein said memory also stores advertising increment data indicative of an amount by which said variable is changed when said advertisements are watched, and wherein said advertising increment data for a first advertisement has a different value than an advertising increment data for a second advertisement.
